(19) United States
(12) Patent Application Publication
(10) Pub. No.: US 2023/0289817 A1
(43) Pub. Date: Sep. 14, 2023

(54) Systems and Methods for Providing Decentralized Support Services in a Virtual Environment

(71) Applicant: Helpshift, Inc., San Francisco, CA (US)

(72) Inventor: Erik Ashby, Lehi, UT (US)

(21) Appl. No.: 18/120,868

(22) Filed: Mar. 13, 2023

Related U.S. Application Data
(60) Provisional application No. 63/319,688, filed on Mar. 14, 2022.

(51) Int. Cl. G06Q 30/015; G06T 17/00; H04L 9/32

(52) U.S. Cl. CPC G06Q 30/015; G06T 17/00; H04L 9/3213; H04L 9/3226; H04L 9/3271

(57) ABSTRACT

Systems and methods for enabling a person who is experiencing and interacting in a virtual environment to obtain customer support or other form of assistance within the environment for an object, service, or experience they interact with in the virtual environment. In some embodiments, this may include the option of obtaining support or a form of assistance from avatars or objects in the virtual environment. In one embodiment, this may be enabled by converting or transforming a request for assistance into an object (referred to as a support request object herein) in the virtual environment.

### CROSS REFERENCE TO RELATED APPLICATION

This application claims the benefit of U.S. Provisional Application No. 63/319,688, filed Mar. 14, 2022, and titled “Systems and Methods for Providing Support Services in a Virtual Environment”, the contents of which is incorporated in its entirety (including the Appendix) by this reference.

### BACKGROUND

Virtual and augmented reality experiences are becoming more and more popular. Typically, a user enters and interacts with a virtual environment using a dedicated device, such as a headset or glasses. A natural evolution of this type of experience is that of a person being represented by an avatar that exists and interacts within a virtual world with objects, other avatars, and the virtual environment. In some cases, this virtual world or reality may be augmented by images or representations of objects in the real, physical world. Such a virtual world or environment has been termed a “metaverse¹”. ¹ Metaverse refers to the concept of a highly immersive virtual world where people gather to socialize, play, and work. Merriam-Webster.

As with the physical “real” world, a person experiencing the metaverse may encounter a problem in using a product or service, such as a virtual application, a delivery service, a virtual device, a business-related service, or another aspect of a virtual world. In some cases, the virtual form of the application or device may correspond to an actual real-world version of the same application or device. Whereas in the physical world, a person would contact the store from which they purchased a product, or the “brand” represented by the product or service to obtain customer support or another form of assistance, this approach is not possible in a virtual environment.

The reasons for this are several but in general, may typically be described as relating to one or more of the following:
a lack of a contact within the virtual environment for a specific product or service from which to seek assistance, and an effective way to describe the support desired within the virtual environment;
   this is an example of the limits of a virtual environment and the necessity for a user to exit that environment to perform certain tasks;
      in one sense, this is a result of a lack of a way to seek support for a product or service in the virtual environment without leaving the virtual environment and instead needing to contact a customer service or support provider using a communication channel outside of the virtual environment;
      similarly, this is a result of not having design elements that logically fit into the vastly different types of possible virtual environments and that provide a clear way for an avatar/user to seek assistance, that is a lack of a standardized and recognizable form or process within the virtual environment for seeking support assistance with applications, products, services, or features of the virtual environment;
in many cases, the insufficiency of support services also results from a need to provide a customer service or support representative with contextual information about the service request, such as a product or service type, a location, an identify of a service requester, a serial number or other identification of a product, a current state, error messages or error codes for a product or service, as examples, and an inability to provide that information to a source of assistance while in a virtual environment;
   in some cases, this information may not be available or even if available, there may not be a process for collecting and/or transferring the information to the appropriate object or avatar in the virtual environment to obtain the desired assistance;
a lack of a verifiable association between an avatar in the virtual environment and a real (physical) person to enable user authentication, verification, and personalized and secure assistance or support services;
   this relates to the problem of establishing a verifiable identity for an avatar so that the avatar or the real person represented by the avatar can be associated with a virtual world product or service and the avatar can be authorized to request and receive the support services;
      this also relates to the need for a secure identity verification system that protects personal data and information from compromise, whether the personal data or information is provided by a real person or by their avatar;
a lack of an infrastructure to provide customer support in a multi-brand environment to enable a user to obtain assistance from multiple entities in a decentralized economic system while remaining in the metaverse experience;
   this relates to the problem of a virtual environment containing products or services from multiple sources and a person (in the form of their avatar) desiring a support service available for each without leaving the virtual environment, and considering the product, service, or context (where relevant to the request) for the customer service or support request;
      this also indicates the significance of collecting relevant contextual or identifying data about a product or service and enabling it to be provided to the appropriate object or avatar in the virtual environment;
         for example, in the “real” physical world, the context in which a request for customer service arises may include day, time, current state of a device, displayed or inferred error messages, and this information is used by a customer service provider to determine how best to assist a customer;
      this concern may also relate to the lack of an ability to obtain assistance from other people/avatars, which in some cases may be beneficial in providing a solution to a user's problem by accessing the “wisdom” and experience of a group.

Embodiments of the systems and methods described herein are directed to solving these and related problems individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to a system and methods for enabling a person who is experiencing and interacting in a virtual environment to obtain customer support or other form of assistance within the environment for an object, service, or experience they interact with in the virtual environment. In some embodiments, this may include the option of obtaining support or a form of assistance from avatars or objects in the virtual environment. In one embodiment, this may be enabled by converting or transforming a request for assistance into an object (referred to as a support request object herein) in the virtual environment.

The support request object may include or be associated with data and information regarding the avatar/requester, the purpose of the request, the context in which the request is made, or the product or service for which the assistance is being requested, as examples. The object representing the request may then be controlled by the person (in the form of their avatar in the virtual environment) who requested the assistance. This may facilitate actions and access to sources of assistance not otherwise possible when a centralized support system is used, where such a system requires seeking and obtaining support from a single source.

In some embodiments, the disclosed system and methods may comprise elements, components, or processes that are configured and operate to provide one or more of:
Support services for a virtual environment and/or location in the virtual environment containing “objects” representing devices, experiences, products, or services associated with a plurality of sources or brands, and that may be utilized within the virtual environment;
Support services that consider the context of one or more of the requester/avatar, the object for which assistance is requested, the virtual environment, the location in the virtual environment, and the relationships between them;
Enabling support services or other forms of assistance to be provided in response to a support request in the form of a support or assistance request object;
   In one embodiment, an avatar indicates a desire to obtain a form of assistance or support;
      In one embodiment, this may be determined by an avatar interacting with an object, where the object represents a device, product, or service, for example;
      The avatar's request for assistance or support initiates a process to generate a support request;
   The request for support or assistance is converted into a support or assistance request object in the virtual environment;
   In one embodiment, the support or assistance request object can be transferred or otherwise made available to other sources of support or assistance;
      The other sources of support or assistance may include other avatars;
      The other sources of support or assistance may include sources of data, information, advice, or access to other information or systems;
         The sources of data, information, or advice may reside within or outside of the virtual environment);
   In one embodiment, conversion of a request into an object in the virtual environment provides a mechanism for transfer of information or data related to the request in a secure manner between avatars or objects within the virtual environment and/or sources of assistance outside of the virtual environment;
      In one embodiment, data and information related to or relevant to the request (such as regarding the requester, the state of the product or service for which assistance is being requested, or the environment around the product or service) may be stored on a blockchain and/or associated with a non-fungible token (NFT), or other form of token;
         The stored data and information may include data that may be used to verify the identity of the avatar and/or the person controlling the avatar, along with an indication of the rights or privileges of the avatar and/or person as those relate to the product or service for which assistance is being requested;
   In one embodiment, conversion of a request into an object in the virtual environment provides a mechanism for establishing a “market” in which such objects may be auctioned, traded, sold, bartered, commented on, transferred, interacted with, or otherwise exchanged;
      This may assist in enabling a more efficient way for the request to be responded to, by making other sources of assistance available to a requester;
      This reduces reliance on a central source of support or assistance for an object in the virtual environment, and increases the likelihood of the requester receiving a satisfactory response to their request by permitting access to the knowledge and experience of others, and the most efficient means of responding to their request;
      The disclosed approach to providing support or assistance in response to a request may promote collaboration between avatars, or between sources of products or services;
      The disclosed approach to providing support or assistance in response to a request empowers the requester to seek and identify the most efficient solution to their problem instead of having to rely solely on a centralized source of support services;
A secure and verifiable way of determining the rights or abilities of an avatar to request and receive support services. The methodology or approach used to perform this function may vary, depending upon the requested form of assistance, and whether the rights pertain to the avatar and/or to the person controlling the avatar. As non-limiting examples, it may be necessary to:
   verify the association of an avatar with a real person and establish the rights or permissions of that person;
   verify the identity and rights of an avatar with a verifiable token (such as an NFT), where this may relate to the rights of the avatar in the virtual environment and may not require confirmation of the identity of the person controlling the avatar;
   verify the identity of an avatar using a secure and accepted verification method in the virtual environment;
      in each example, a goal is to enable the avatar to identify itself and establish its rights, privileges, or entitlements, and/or to enable a person to provide “proof” of their association with (or control of) the avatar (if necessary in the situation) and to establish their rights;
      in some cases, identity verification may be part of a process to enable an avatar or real person to establish their ownership of an object, or their entitlement to use a service or type of support;
   this illustrates how the method used to verify identity may vary depending on the context in which the request for assistance is generated;
      in some cases, an avatar may be part of a transaction involving a transfer of “credits” or virtual funds—in this case, it may not be necessary to verify the identity of the person controlling the avatar to provide the requested assistance;
      in some cases, an avatar may be interacting with a service provider in the real world—in this case, it may be necessary to verify that the avatar is being controlled by the person who is authorized to receive the assistance;
Support services in the virtual environment that can (if needed) connect and communicate with “real” world digital platforms and support tools, and real-world support agents to obtain the requested assistance;
   this interconnection between the virtual environment and real-world support tools may be used so that existing real-world support agents can support the virtual world without changing their support workload or practices;
      as an example, a support agent may use a CRM tool to respond to or engage in a “chat” with support requests. These agents can continue to respond as needed to a request made in the virtual space, while continuing to provide services to requests for assistance made in the real-world;
   this interconnection between the virtual environment and the physical real world may include services provided in the virtual environment that are tied to the support of real-world objects represented in the virtual space;
      as an example, this would permit a user (in the form of their avatar) to obtain customer assistance in the virtual environment for an object in that environment where the object has a real-world version owned by the user and the customer assistance can be applied to the real-world object; and
Support services in the virtual environment may be accessed using virtual/augmented reality devices and techniques, and support may be provided for a location in the virtual environment, an object, or an asset, and support may be obtained from a menu/kiosk, or otherwise integrated with a virtual world experience.

As part of, or in addition to, enabling the provision of customer support services or other types of assistance within a virtual environment, the disclosed systems and methods may also provide the following advantages, services, or capabilities:
Consideration of the context in the virtual environment that may be needed to provide automated or self-help support;
   this relates to the fact that in the virtual environment the type of support that is needed may depend on the context at the time assistance is requested, especially for self-help or automated support;
      for example, for self-help or automated help to be provided within a virtual environment, the system may need to know where an avatar is, what objects or avatars they might be interacting with, and what the avatar is doing so that the appropriate help or automated assistance can be provided;
An effective infrastructure to provide customer support in a multi-brand virtual environment and to enable the user to obtain assistance from the correct entity when multiple entities exist;
   this relates to the situation that in a virtual environment, the user experience is not provided by a single brand, but instead by a mixture of experiences, objects, and services that are created by multiple brands;
   for example, in the virtual world, an avatar may be standing in a virtual mall surrounded by different stores, where each store experience is created by a different brand;
   similarly, in the virtual world, an avatar may be in their own virtual space, but own specific virtual objects (such as a painting, a virtual car, a radio, or other object) that are created by different brands and for which they desire support if the object is not performing as expected in this world.

In some embodiments, a user may obtain the customer service or support using a device such as a smartphone or tablet computer. In such situations, the following functions or capabilities may be provided:
The user's phone may function as a “window” for viewing and interacting with a specific virtual or augmented reality environment;
The “window” may include an element for requesting support in the virtual environment (such as a kiosk in the virtual environment) that can be used to submit a request for support and to initiate a support experience;
The provided support may be based on or include consideration of elements of the real-world context of the requester and/or those of the virtual environment;
   as an example, such as by combining a requestor's real-world identity with their real or virtual location and information about one or more objects in the virtual environment; and
Support services may be provided in an augmented reality experience/environment in which connection and communication with real-world support tools and/or support agents is enabled, and information or other forms of assistance can be transferred between the virtual/augmented environment and the real environment.

In some embodiments, in addition to providing customer support and other services for objects in a virtual environment, the disclosed system and methods may provide one or more of the following functions or capabilities:
An identity verification and (for an avatar and/or user) authorization process that can perform one or more of the following tasks:
   identify and determine the rights of an avatar or person controlling an avatar;
   relate an identity for an avatar in a virtual environment to a real-world person;
   determine if the real-world person (and by extension their avatar) are authorized to receive support services for an object in the virtual environment;
   this may include the ability to generate an identity for a user that can be used in the virtual environment if they do not presently have one;
   this may include the ability to verify the identity and authorized services that can be provided to an avatar and/or real-world person using data stored on a blockchain, by processing an NFT, or by using other secure and accepted verification method (such as multi-factor and/or multi-channel authentication);
An ability to notify support services in the virtual environment and/or the real-world when a user or service requester cannot be verified;
   this is to prevent a person/avatar from obtaining access to resources or assistance that they are not entitled to;
A set of processes to enable a service or support request to be associated with a user and treated as an object or asset belonging to the user/avatar;
   this allows the user (in the form of their avatar) to transfer the support request to others for advice or assistance;
      this capability may enable the development of an economy or market in the virtual environment based on the value of service requests (e.g., by establishing ownership of property and the opportunity for bidding, exchange, trades, valuation, or other forms of property transfer) and encourage and enable collaboration within the virtual environment to more effectively address service requests.

In one embodiment, the disclosure is directed to a method for providing customer service or support within a virtual or augmented reality environment. In some embodiments, this disclosure is directed to creating virtual support “tickets” that are independent of a brand, and as such can be more easily routed between brands to solve a problem for a customer or user. In addition, since the virtual tickets are independent of a brand this is expected to encourage 3^{rd} party services to be developed to solve both common and less frequent problems encountered by users that involve a single or multiple brands.

In one embodiment, this may be done by treating a request for assistance as an object in the virtual environment. In such an embodiment, the disclosed method may include the following steps, stages, functions, processes, or operations:
Receive or identify a request from an avatar in a virtual environment for assistance with a product or service, with the product or service represented as an object in the virtual environment;
   as non-limiting examples, the request may be generated by the avatar visiting a kiosk, sending a communication, identifying the object and executing a process or operation (such as touching an element on the object or picking up the object), or moving to a specific location in the virtual environment (such as a marker or building);
   a real person may also access the virtual environment via a web-page, a mobile application, or other support interface and may not be required to have an avatar;
In response to the request, identify the product or service for which assistance is requested and determine if the avatar (and by inference, the real-world person/user corresponding to the avatar) is authorized to obtain the requested assistance. This step or stage of the process may be optional, and used as a gating step to verify that an avatar (and by inference the real-world person) is authorized to receive the product or service assistance, and therefore to participate in the conversion and transfer of a support object:
   with regards to the avatar, this may include determining the identity, location, and/or context of the avatar in the virtual environment and the services it is authorized to receive (this may be accomplished using blockchain data, an NFT or other token, or other form of verification or authentication), and/or determining the real-world person that is supposed to correspond to the avatar and verifying that the authorized person is controlling the avatar when the request is made;
      when needing to verify the identity of the real-world person in control of an avatar, in some embodiments, this may involve a form of two-factor and/or two-channel authorization that uses both virtual and real-world objects, devices or processes as a channel for transmission, or a source of, verification data;
   with regards to the object representing a product or service, this may include verifying that the real-world person is entitled to receive the requested assistance for the virtual environment product or service;
      to accomplish this, specific information about the object may need to be collected, including but not limited to (or required to include):
         identifying the object by one or more of name, brand, serial number, model, version, or type, as examples;
         identifying the source of the object (if not apparent from the brand), such as a real-world or virtual-world store, or other form of provider; and
         determining the relationship between the object and the requester (such as if the requester is an owner, a licensed user, or is associated with an NFT, as non-limiting examples);
Convert the request for assistance into a virtual object (referred to as a support request object herein) in the virtual environment;
   in one embodiment, a support request object may be created as part of a Decentralized Autonomous Organization (DAO) where there the support object would be referenced, managed, and made secure. This process would include providing links to where the support details are stored in any corresponding integrated support services;
   in some embodiments, this may enable the development of a “market” and related economy directed to support requests, thereby allowing the pricing, valuation, payment for, trading, and transfer of such requests as objects;
   in one embodiment, the object may be created using blockchain technology to ensure that there is a secure record of one or more of the creation of the ticket, the relevant contextual or other information, and the owner (e.g., the person controlling an avatar or an avatar with no reference to a person) of the support request object;
   the support request object may be owned and managed by an avatar and/or the person who owns the avatar, and/or by the person who initially created the request;
      this allows the owner to control what happens to the support request, including who is able to see the details, where they can go for support, and to know when the support request is fulfilled;
The support request object is recognized as a support-related object used as part of a support activity. It may be associated with a published schema so that processes can access the object and efficiently understand the data that is contained within it. In one embodiment, the support request object may have data associated with it that is stored on a blockchain or in the form of a token or NFT, where the data may include one or more of data, information, or metadata regarding the request. In one embodiment, the data, information, or metadata regarding the request may include, but is not limited to or required to include:
   data, information, or metadata regarding the requesting avatar and/or person in control of the avatar—this data may be used to verify the identity of the requester and establish their rights and privileges with regards to the product or service for which assistance is requested;
   data, information, or metadata regarding the product or service for which assistance is requested;
      this may include identifying the object by one or more of name, brand, serial number, model, version, or type, as examples;
      this may include identifying the source of the object (if not apparent from the brand), such as a real-world or virtual world store or provider;
      the state, status, or location of the object (such as if an error code was generated, the configuration of the object, the process or function the product was requested to execute or was executing, or other relevant information, as examples);
      this may include data, information, or metadata regarding the requested type of service or assistance, such as a requested document, an answer to a question, a video illustrating how to configure a device, or a link to a source, as examples;
In one embodiment, the process may include verifying the identity of the person controlling the avatar;
   this may involve a form of two-factor or two-channel authorization that uses both virtual and real-world devices or processes;
In one embodiment, the process may include data, information, or metadata regarding what the avatar (and hence the person controlling the avatar) is willing to pay, do, or assist another avatar/person to do in return for assistance in responding to their support request;
   this may include payment of funds for use in the virtual environment, payment of funds for use outside of the virtual environment, or another item of value (such as an object (support or otherwise) that is part of a trade);
Enable the avatar or the person making the request to transfer the object formed from the support request to a support entity, where the support entity may be another avatar, a brand, may be located in the virtual or real environment, or the avatar or person making the request may cause a process to be executed on the product, service, or support request object so that they can obtain support;
   this may be the act of transferring the object to a brand so that they can solve the problem;
   in one embodiment, this may cause the object representing the product or service for which support is desired being changed in appearance, location, or in another characteristic;
   in one embodiment, the support request object may be identified by a specific characteristic or appearance (such as a shape, color, or logo, as examples), with that characteristic or appearance depending upon the status or state of the request for support (such as submitted, being considered, accepted, or completed, as examples);
   in one embodiment, the location to which a support request is brought may be a form of marketplace in which other avatars may “bid” on responding to the request, may offer payment in the form of a trade, service, or currency, or may provide a different object as an inducement to be allowed to respond to the service request;
      in one embodiment, the process executed on the product, service, or support request object may indicate that the support request object is available to be transferred through a marketplace;
      if desired, enable the request to be responded to by more than one avatar, and arrange payment for one or more of those responding;
   the avatar in possession of the product or service needing support may be able to control what information can be seen and is shared when the support request object (or ticket) is transferred or placed into an auction for bidding by others to provide the requested support service;
   in some embodiments, the disclosed process may include an automated process that determines the “best” support entity based on the data collected and matching it with the qualities of the support entities in the virtual or real environment;
      these qualities may include but are not limited to the types of services offered by an entity, previous experience in providing assistance, or previous experience with the product or service for which assistance is requested, as non-limiting examples;
      for example, if the problem encountered (and for which assistance is requested) is a payment problem when purchasing a product or service, then the automated process may determine that a bank or payment processor is best suited to solve the problem and will enable the purchaser to submit a support request to the bank or payment processor support team (which may be in the virtual environment and/or in the real world);
Establish a method of communication between the requesting avatar and the current entity (a brand or other avatar) who the support request object was transferred to for resolution, so that support can be provided by way of messaging, voice, video, or through an automated tool (such as a chat bot);
   where the requested assistance or support may be provided in the form of a communication, information, instructions, a video to watch, a location to visit, or a process to execute (which may be provided in the form of an object), as non-limiting examples;
   when assistance has been provided to the avatar/requester, an indicator on a product or associated with the support/service request when it is viewed as an object may be altered (such as a change to its color, shape, or appearance) to indicate that the support request has been responded to and the problem resolved;
Enable the avatar (in one embodiment, based on a recommendation from a support entity) to transfer the object to a different support entity if the problem cannot be solved by the entity who first attempted to provide the assistance;
   For example, if a store support team cannot solve the problem, then they (or the requester) are able to transfer the ticket transferred to the bank support team to solve the problem;
      In some embodiments, a transfer may be performed by either the requestor or the support entity to which the requester initially provided the support object;
Enable the support entity that was able to solve the problem (i.e., to provide the requested assistance) to indicate to the requesting/owning avatar (or person) that the assistance has been provided;
   enable the owning avatar to confirm that the problem has been resolved;
After a response to the support request has been received by the requesting avatar, enabling the requester to provide a payment to the avatar or avatars that provided the assistance;
   this may be by the transfer of tokens, currency, or another item of value;
   this may be initiated by the requesting avatar visiting a bank, office, kiosk, or other object in the virtual environment.

In one embodiment, the disclosure is directed to a system for providing customer service or support within a virtual environment. The system may include one or more non-transitory computer-readable media including a set of computer-executable instructions and an electronic processor or co-processors. When executed by the processor or co-processors, the instructions cause the processor or co-processors (or a device or apparatus of which they are part) to perform a set of operations that implement an embodiment of the disclosed method or methods.

In one embodiment, the disclosure is directed to one or more non-transitory computer-readable media including a set of computer-executable instructions, wherein when the set of instructions are executed by an electronic processor or co-processors, the processor or co-processors (or a device or apparatus of which they are part) perform a set of operations that implement an embodiment of the disclosed method or methods.

In some embodiments, the systems and methods described herein may provide services through a SaaS or multi-tenant platform. The platform provides access to multiple entities, each with a separate account and associated data storage. Each account may correspond to a user, set of users, an entity offering users customer services and support, or an organization, for example. Each account may access one or more services, a set of which are instantiated in their account, and which implement one or more of the methods or functions described herein.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments disclosed or described herein are susceptible to various modifications and alternative forms, specific embodiments have been shown by way of example in the drawings and will be described in detail herein. However, the exemplary or specific embodiments are not intended to be limited to the forms described. Rather, the present disclosure covers all modifications, equivalents, and alternatives falling within the scope of the appended claims.

### BRIEF DESCRIPTION OF THE DRAWINGS

Embodiments of the invention in accordance with the present disclosure will be described with reference to the drawings, in which:

FIG. 1(a) is a diagram illustrating a system including a set of elements, components, functions, or processes that may be implemented as part of some embodiments;

FIG. 1(b) is a flowchart or flow diagram illustrating a method, process, set of operations, or set of functions for enabling a person to obtain customer service or assistance for an object in a virtual environment without leaving the virtual environment, in accordance with some embodiments;

FIG. 2 is a diagram illustrating elements or components that may be present in a computer device, server, or system configured to implement a method, process, function, or operation in accordance with some embodiments; and

FIGS. 3-5 are diagrams illustrating an architecture for a multi-tenant or SaaS platform that may be used in implementing an embodiment of the systems and methods disclosed herein.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory computer-readable data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the disclosure may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, in some embodiments, the systems and methods described herein may provide services through a SaaS or multi-tenant platform. The platform provides access to multiple entities, each with a separate account and associated data storage. Each account may correspond to a user, set of users, an entity offering users customer services and support, or an organization, for example. Each account may access one or more services, a set of which are instantiated in their account, and which implement one or more of the methods or functions described herein.

As used herein, the terms “metaverse”, “virtual environment”, “virtual reality”, or “virtual world” refer to a computer-simulated environment which may be populated by multiple users who can each create and be represented by a personal avatar, and simultaneously and independently explore the virtual world, participate in its activities, interact with objects, and communicate with others.² A virtual world or environment may include aspects of the physical or real-world, in which case the experience may be referred to as an “augmented reality”. ² See Wikipedia entry. The avatars can be textual, graphical representations, or live video avatars with auditory and touch sensations. The user accesses a computer-simulated world which presents perceptual stimuli to the user, who in turn can manipulate elements of the modeled world and thus experience a degree of presence. Such modeled worlds and their rules may draw from reality or fantasy worlds. Example rules are gravity, topography, locomotion, real-time actions, and communication. Communication between users can range from text, graphical icons, visual gesture, sound, and rarely, forms using touch, voice command, and balance senses.

As non-limiting examples, when users interact in and with the metaverse, they may experience one or more of the following:
persistent, virtual interactive 3-dimensional worlds and immersive experiences (which are accessed via one or more of VR, AR, and mobile devices, as examples);
mixed brand experiences involving products or services provided by multiple and different sources;
decentralized self-sovereign identities, with each identity/avatar owned and controlled by an individual in the real-world;
decentralized metaverse assets/objects that may be owned by one or more individuals/avatars;
virtual objects that may include land, structures, locations, works of art, tokens, rewards, equipment, services, devices, specific functions, or executable processes, as non-limiting examples;
   in some embodiments, a virtual object may correspond to an actual object in the real-world, such as a location, a building, a company, a device, or an animal, as non-limiting examples; and
a decentralized economy, in which objects may be associated with non-fungible tokens (NFTs), and the availability of direct person (i.e., avatar)-to-person (avatar) transactions.

In some embodiments, to provide “contextual” based customer support in a virtual world for a virtual product or virtual service may involve implementation of one or more of the following functions or capabilities:
Existence of a virtual object (such as a ball, a service emblem, a designated location, or a kiosk, as non-limiting examples) or an event trigger (such as an avatar pressing a button, standing on a square, or moving to a designated location, as non-limiting examples) that can be used by an avatar to generate a request for support and/or initiate a support experience;
Awareness of the context of the user/avatar in the virtual environment including as non-limiting examples, the virtual location, nearby objects, the avatar's recent/current experience or actions, the avatar's virtual or corresponding real-world identity, or the brand ownership or association (if applicable) for an object;
   For example, awareness that a person's avatar is in a virtual Starbucks lounge, sitting at a table, in front of a game of chess;
A virtual identity (typically in the form of an avatar) that is managed by a real-world person/user and associated with specific data that can be shared by the user in control of the avatar with support service providers to authenticate the user and establish that they (the user) are entitled to the desired support services (such as verification that they are 18, or that they have paid for the product or service, as non-limiting examples);
   the data or information used to establish the rights of an avatar and/or a person, or to verify the identity of a person controlling an avatar may be stored or encoded in a blockchain, associated with an NFT, or stored in another suitable data storage component;
A virtual environment experience with which a user's avatar can interact to obtain support, including (as examples) one or more of self-help sources, artificial intelligence driven menus, a voice chat, a text chat with voice-to-text capabilities, a device that presents a video, a display for presenting a document, or interactive workflows, as non-limiting examples;
   in some embodiments, a service agent chat record (in text format) or voice chat may appear as a hologram or as an avatar that another avatar can interact with; and
A support platform and routing service or functionality to execute or otherwise provide an experience based on the specific context of the avatar and/or the product or service for which support is requested;
   for example, if the user is in a virtual Starbucks, then Starbucks help will be displayed;
   the provided experience may include (but is not limited to or required to include) use of a bot, an automated event or sequence of events, a connection/routing to a real-world agent, a help or customer support ticketing process, or support agent communication tools, as non-limiting examples.

Conventionally, support is provided by a brand that owns and controls how support is provided. As an example, if a user or customer requires customer assistance or support for a product or service, they typically will go through a process similar to the following:
1. A user/person contacts the support center;
2. The support center (staffed by the brand) creates a support ticket that is owned and managed by the brand;
3. The support center provides customer service to the user;
4. If the brand cannot solve the problem (for example if the problem is not with the brand but with some other brand), they either will reach out to a secondary brand or most often will tell the user to contact the other brand and create a new support ticket with that brand;
5. In this case, the user is required to start a second interaction with the second brand to solve the initial problem.

However, technology and services are often mixed (meaning that they are provided by multiple brands), and as users engage more with decentralized models in the future (such as the metaverse), brands and services are expected to increase the frequency with which they are mixed and integrated into a single experience.

Unfortunately, this tendency is not addressed effectively by conventional approaches to delivering customer support services. The conventional model where a support request ticket is owned by a brand limits the ability of a user to seek solutions to problems across multiple brands. Instead, they are required to have individual interactions with each brand and each brand is oblivious to the previous interactions.

As mentioned, an aspect that makes providing customer service or support in a virtual environment more difficult than in the real-world is that in a virtual world there can be many different objects, types of objects, products, services, and places, and each may be associated with a different source or brand. For example, a person's avatar may be in their virtual living room with several different objects on a counter that were purchased from different brands (a virtual book, a virtual board game, a virtual device, a radio, and a portal to a virtual experience, as non-limiting examples). Each object would be expected to have different support needs and different contextual information, and a support platform needs to be able to distinguish between each object and enable a user to receive support services applicable to that object from its associated source or brand.

In contrast, in a conventional real-word environment, each brand and their support are self-contained, and the support is presented inside of a desktop application, a dedicated chat, a web-page, or a mobile application, as examples. However, in a virtual environment, brands will be interspersed and provide different products, services, or experiences at the same time and often in the same place in the virtual environment. Because of this situation, it is important to have sufficient contextual information available about the virtual world and the virtual object of interest to determine what support services to present. The contextual information may be related to specific objects, locations, device states, events, or triggers unique to a brand or source of an object.

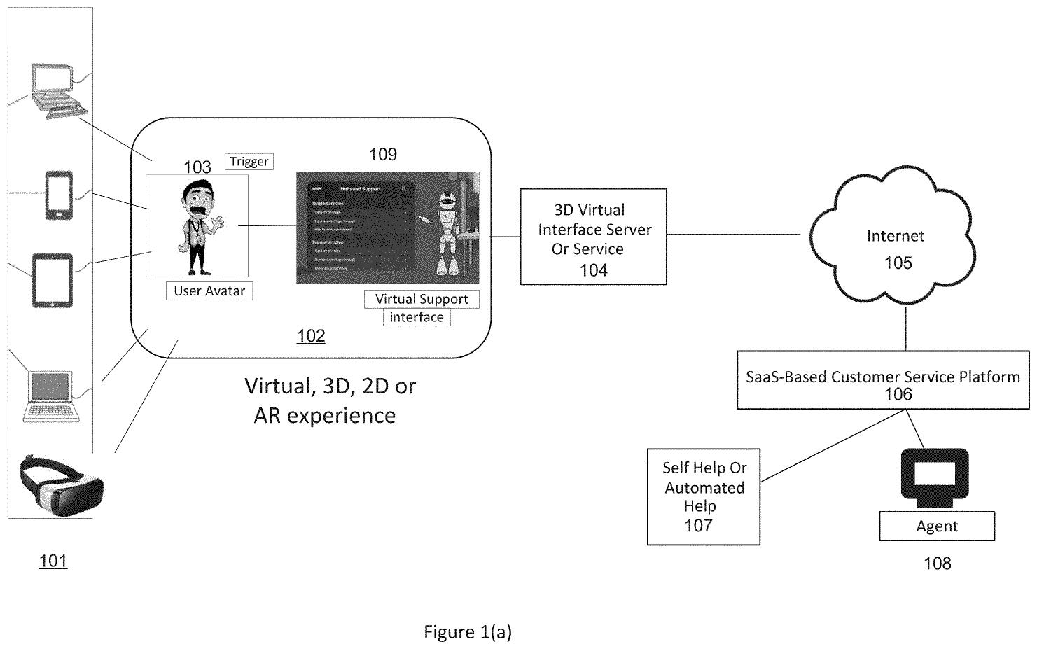

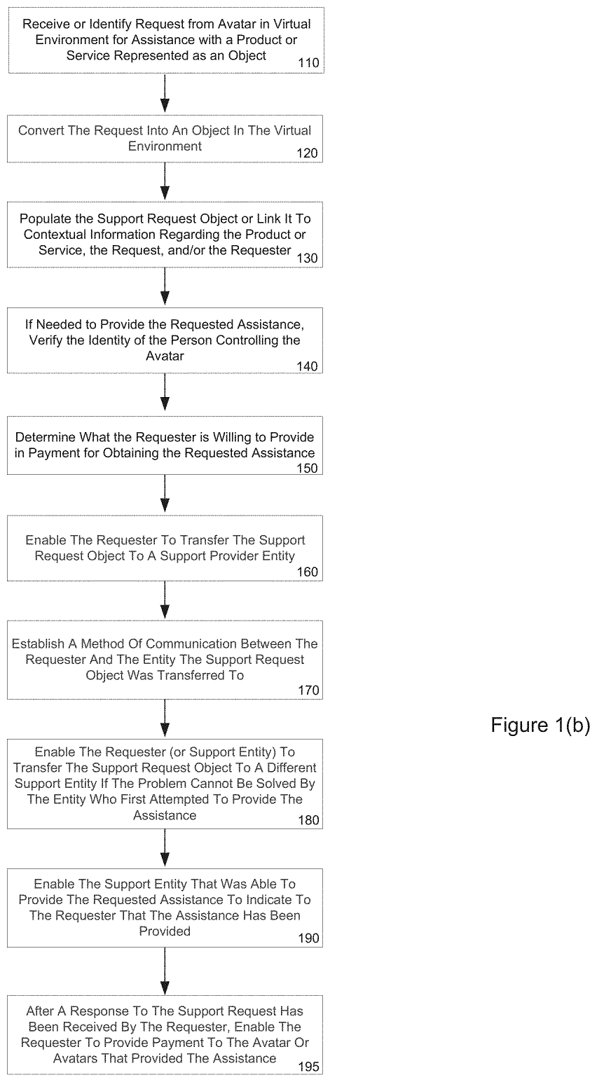

FIG. 1(a) is a diagram illustrating a system including a set of elements, components, functions, or processes that may be implemented as part of some embodiments. As shown in the figure, a real-world person uses a suitable device 101 to experience and interact with a virtual experience or environment 102. The device may be a computing device, tablet, mobile phone, or dedicated virtual reality headset, as non-limiting examples. The virtual experience or environment 102 may be one of a virtual (artificial) reality, augmented reality, or similar experience, and may be provided by a gaming or interactive application.

Within virtual experience or environment 102, the real-world person using device 101 may be represented by an avatar 103. Virtual experience or environment 102 may be generated and managed by a remote server 104 (as suggested by the element labeled “3D Virtual Interface Server or Service” in the figure). Server 104 may be operated by the provider of the gaming or interactive application the real-world person is using. Server 104 is typically connected to and able to exchange data and information using the Internet 105 and/or one or more intermediate networks.

A SaaS-based customer service platform 106 may also be connected to the Internet 105 and therefore able to exchange data and information, and interact with virtual experience or environment 102, typically via server 104. SaaS-based customer service platform 106 may be connected to and able to provide customer assistance by routing a service or assistance request to a set of self-help or automated help resources 107 (such as a set of documents, links, or a chatbot, as non-limiting examples), and/or to service agents 108 in the form of a real person using a suitable computing device.

In one embodiment, the operator of SaaS-based customer service platform 106 may provide the source of the game, application, interactive experience, or other virtual reality or augmented reality environment or experience (the operator of server 104, as an example) with one or more of the following elements, components, or processes:
A module, plug-in, or application that may be used to determine that support is needed for an object in the virtual experience or environment and to collect or identify the contextual data and information needed to provide effective support services;
A virtual reality, augmented reality, or mobile device customer support module (i.e., an application, routine, or executable set of instructions to accomplish a function, as non-limiting examples) to provide customer service and other forms of assistance that a “brand” may integrate into a virtual reality or augmented reality experience or environment that it is creating and/or managing;
   in some embodiments, a user of a mobile application on a mobile device may be able to seek (or make a request) for support and then go through a process by which an independent ticket is created that is owned by the user and has the same aspects/properties as disclosed herein for a service request object;
A digital customer service and support platform (such as platform 106, or an account on a multi-tenant platform) connected to the virtual reality, augmented reality, or mobile device customer support module and able to exchange data and information with that module; and
Connectivity and access to self-help and agent tools and resources so that the customer support module can access and utilize the self-help and/or real person agents.

In some embodiments, one or more of the modules used to determine if support is needed (or the customer support module) may generate a user interface 109 within the virtual or augmented reality environment to enable avatar 103 to interact with customer support services. Interface 109 may include selectable or activatable elements that avatar 103 may use to indicate a product (such as by model or generic category) or type of service for which assistance is desired, the type of assistance desired, or another aspect of a service request.

As suggested by the “trigger” element in the figure, in some embodiments, a service request may be generated automatically in response to a situation or event. For example, an error message, an avatar performing a specific action or going to a specific place, or an object representing a product or service changing its appearance may be a form of trigger and may indicate that assistance is needed. In some embodiments, such a trigger may automatically generate a service request or ticket.

FIG. 1(b) is a flowchart or flow diagram illustrating a method, process, set of operations, or set of functions for enabling a person to obtain customer service or assistance for an object in a virtual environment without leaving the virtual environment, in accordance with some embodiments. In some embodiments, the illustrated method, process, set of operations, or set of functions may be performed by executing a set of computer-executable instructions, some of which may be executed in a client device and some in a remote server platform.

As disclosed, in some embodiments, a person may obtain customer service or assistance for an object in a virtual environment without leaving the virtual environment by implementing the following steps or stages:
A customer support or assistance platform (such as SaaS-Based Platform 106 of FIG. 1(a)) receives or identifies a request from an avatar (such as Avatar 103 in FIG. 1(a)) in a virtual environment for assistance with a product or service (as suggested by step or stage 110);
   As non-limiting examples, the request may be generated by the avatar visiting a kiosk, sending a communication, identifying the object and executing a process or operation (such as touching an element on the object or picking up the object), or moving to a specific location in the virtual environment (such as a marker or building);
   A real-world person may also access the virtual environment via a web-page, a mobile application, or other support interface and may not be required to have an avatar;
Convert the request into an object (referred to as a support request object) in the virtual environment (or into a service request in the real-world in some embodiments) (step or stage 120);
   In some embodiments, this may enable the development of a “market” and economy related to support requests, thereby allowing the pricing, valuation, payment for, trading, and transfer of such requests as objects;
   In one embodiment, the support request object may be created using blockchain technology to ensure that there is a secure record of the creation of the ticket, the relevant contextual or other information, and the owner of the support request object;
   The support request object will be owned and managed by the avatar and/or the person who controls the avatar, or by the person who initially generated the request for assistance;
   The support request object will be used as part of a support activity and will have a published schema (so that processes can access the object and understand the data that is contained within it);
In one embodiment, the support request object may have data associated with it that may be stored on a blockchain or in the form of a NFT, where the data may include one or more of data, information, or metadata regarding the support request, data, information, or metadata related to the requester and/or to the product or service for which assistance is requested (as suggested by step or stage 130):
   In one embodiment, the data, information, or metadata regarding the request, the requester, and/or the product or service may include (but is not limited to or required to include):
      data, information, or metadata regarding the requesting avatar and/or the person in control of the avatar;
      data, information, or metadata regarding the product or service for which assistance is requested;
         1. this may include identifying the object by name, brand, serial number, model, version, category, or type, as examples;
         2. this may include identifying the source of the object (if not apparent from the brand), such as a real-world or virtual world store or provider;
         3. the state, status, or location of the object (such as if an error code was generated, the configuration of the object, the process or function the product was requested to execute or was executing, or other relevant information);
         4. this may include data, information, or metadata regarding the requested type of service or assistance, such as a requested document, an answer to a question, a video illustrating how to configure a device, or a link to a source, as non-limiting examples;
In one embodiment, the process may include verifying the identity of the person controlling the avatar (step or stage 140);
   this might involve a form of two-factor or two-channel authorization that uses both virtual and real-world devices or processes;
   This may be performed to verify that the person controlling the avatar (and hence the avatar) is entitled to receive the requested support or assistance;
In one embodiment, the process may include data, information, or metadata regarding what the avatar (and hence the person controlling the avatar) is willing to pay, do, or assist another avatar/person to do in return for assistance in responding to their request for support (step or stage 150);
   this may include payment of funds for use in the virtual environment, payment of funds for use outside of the virtual environment, or providing an item or service of value;
Enable the avatar or the person controlling the avatar to transfer the object formed from the support request to a support entity, where the support entity may be another avatar or a brand, and may be located in the virtual or in the real environment (step or stage 160);
   In some embodiments, the avatar or person controlling the avatar may cause a process to be executed on the object for which assistance is requested so that they can obtain support;
      In one embodiment, this may cause the object representing the product or service for which support is desired being changed in appearance, location, or another characteristic;
   In some embodiments, this may be the act of transferring the support request object to a brand or representation of a brand so that the brand can solve the problem;
   In one embodiment, the support request object may be identified by a specific characteristic or appearance, with that characteristic or appearance depending upon the status or state of the request for support;
   In one embodiment, the location to which the support request object is transferred or a process involving the support request object may be a form of marketplace in which other avatars may “bid” on responding to the request, may offer payment in the form of a service or currency, or may provide a different object as an inducement to be allowed to respond to the request;
      If desired, the marketplace may enable the request to be responded to by more than one avatar, and coordinate payment(s) for one or more of those responding;
   The avatar or person responsible for generating the request may be able to control what information can be accessed and is shared when the support request object is transferred or placed into an auction for bidding by others to provide the requested support service;
   In some embodiments, the disclosed system and processes may include an automated process that determines the “best” support entity based on the data collected and matching it with the qualities of the support entities in the virtual or real environment;
      For example, if the problem encountered (and for which assistance is requested) is a payment problem when purchasing a product or service, then the automated process may determine that a bank or payment processor is best suited to solve the problem and will enable the purchaser to submit a support request to the bank or payment processor support team (which may be in the virtual environment and/or in the real world);
Establish a method of communication between the requesting avatar and the entity (a brand or other avatar) who the support object was transferred to for resolution so that support can be provided by way of messaging, voice, or video, or through an automated tool (such as a chat bot) (as suggested by step or stage 170);
   Where the requested assistance or support may be provided in the form of a communication, information, instructions, a video to watch, a location to visit, or a process to execute (which may be provided in the form of an object), as non-limiting examples;
   When assistance has been provided to the avatar/requester, an indicator on a product or associated with the support/service request when it is viewed as an object may be altered (such as a change to its color, shape, or appearance) to indicate that the support request has been responded to and the problem resolved;
Enable the avatar (in one embodiment, based on a recommendation from a support entity) to transfer the object to a different support entity if the problem cannot be solved by the entity who first attempted to provide the assistance (step or stage 180);
   For example, if a store support team cannot solve the problem, then they (or the requester) are able to transfer the ticket transferred to the bank support team to solve the problem;
      In some embodiments, a transfer may be performed by either the requestor or the support entity to which the requester initially provided the support object;
Enable the support entity that was able to solve the problem to indicate to the owning avatar (or person) that the problem has been solved (step or stage 190);
   Enable the owning avatar to confirm that the problem has been solved;
After a response to the support request has been received by the requesting avatar, enabling the requester to provide a payment to the avatar or avatars that provided the assistance (step or stage 195);
   this may be by the transfer of tokens, currency, or another item of value;
   this may be initiated by the requesting avatar visiting a bank, office, kiosk, or other object in the virtual environment.

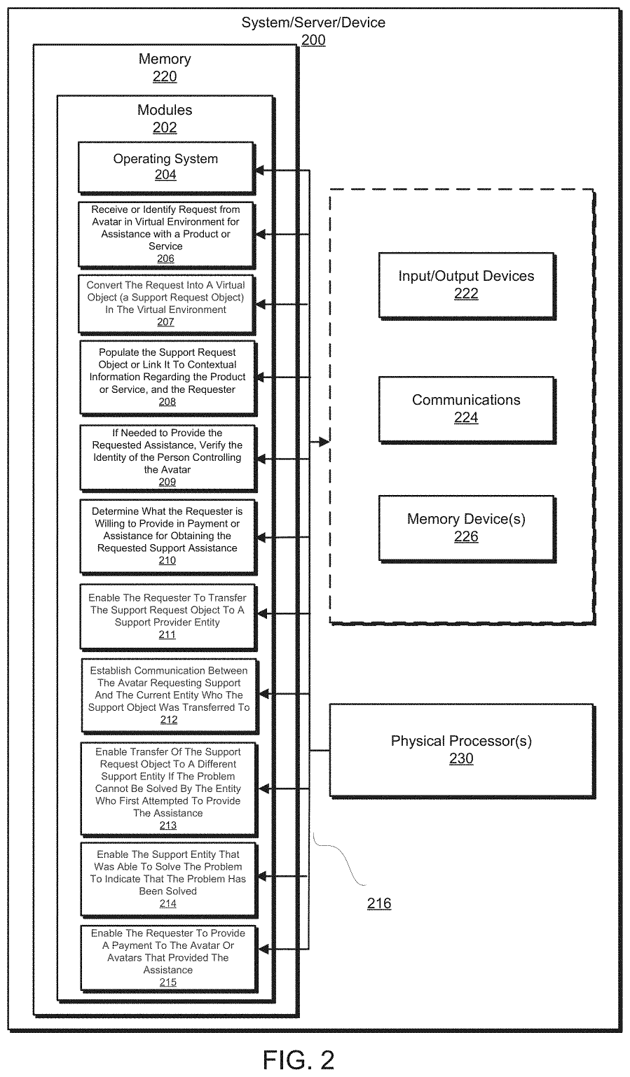

FIG. 2 is a diagram illustrating elements, components, or processes that may be present in or executed by one or more of a computing device, server, platform, or system 200 configured to implement a method, process, function, or operation in accordance with some embodiments. In some embodiments, the disclosed system and methods may be implemented in the form of an apparatus or apparatuses (such as a server that is part of a system or platform, or a client device, as non-limiting examples) that includes a processing element and a set of executable instructions. The executable instructions may be part of a software application (or applications) and arranged into a software architecture.

In general, an embodiment of the disclosure may be implemented using a set of software instructions that are designed to be executed by a suitably programmed processing element (such as a GPU, TPU, CPU, microprocessor, processor, controller, state machine, or computing device, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent one or more of a server, client device, platform, or other form of computing or data processing device. Modules 202 each contain a set of executable instructions, where when the set of instructions is executed by a suitable electronic processor (such as that indicated in the figure by “Physical Processor(s) 230”), system (or server, or device) 200 operates to perform a specific process, operation, function, or method.

Modules 202 may contain one or more sets of instructions for performing a method or function described with reference to the Figures, and the descriptions and disclosure of the functions and operations provided in the specification. These modules may include those illustrated but may also include a greater number or fewer number than those illustrated. Further, the modules and the set of computer-executable instructions that are contained in the modules may be executed (in whole or in part) by the same processor or by more than a single processor. If executed by more than a single processor, the co-processors may be contained in different devices, for example a processor in a client device and a processor in a server.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 216, which also serves to permit processor(s) 230 to communicate with the modules for purposes of accessing and executing instructions. Bus or communications line 216 also permits processor(s) 230 to interact with other elements of system 200, such as input or output devices 222, communications elements 224 for exchanging data and information with devices external to system 200, and additional memory devices 226.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor or co-processors cause the processor or co-processors (or a device, devices, server, or servers in which they are contained) to perform the specific function, method, process, or operation. As mentioned, an apparatus in which a processor or co-processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed system and methods, such as for:
Receiving (or identifying) a request from an avatar in a virtual environment for assistance with a product or service, with the product or service represented as an object in the virtual environment (as suggested by module 206);
Converting the request into a virtual object (referred to as a support request object) in the virtual environment (module 207);
Populating or associating the support request object with data and information (such as may be stored on a blockchain or in the form of an NFT or token), where the data and information may include one or more of data, information, or metadata regarding the request and related to the requester, and/or to the product or service for which assistance is requested (as suggested by module 208):
Verifying the identity of the person controlling the avatar (if needed, and as represented by module 209);
Providing data, information, or metadata regarding what the avatar (and hence the person controlling the avatar) is willing to pay, do, or assist another avatar/person to do in return for assistance in responding to their support request (module 210);
Enable the avatar or the person making the support request to transfer the support request object to a support provider entity, where the support entity may be an avatar or a brand, and may be located in the virtual or real environment (module 211);
   In some embodiments, the avatar or person making the support request may cause a process to be executed on the support request object so that they can obtain support (such as changing its appearance, causing it to generate a signal, causing it to transfer to another entity);
Establishing a method of communication between the avatar requesting support and the current entity (e.g., a brand or other avatar) who the support request object was transferred to for resolution—this enables support to be provided by way of messaging, voice, or video, or through an automated tool (such as a chat bot) (module 212);
Enabling the avatar or person requesting support to transfer the support request object to a different support entity if the problem cannot be solved by the entity who first attempted to provide assistance (module 213);
   In one embodiment, the transfer may be based on a recommendation from a support entity;
   In one embodiment, the current entity (to whom the support request object was initially provided) may be able to transfer the support request object to another entity;
Enabling the support entity that was able to solve the problem (i.e., to provide the requested support assistance) to indicate to the avatar (or person) who initially created the request for support that the problem has been solved (module 214); and
After a response to the request for support or assistance has been received by the requesting avatar, enabling the requester to provide a payment to the support entity (e.g., the avatar or avatars) that provided the assistance (module 215).

In one embodiment, a method for providing proof or verification of the identity of a person controlling an avatar within a virtual or augmented reality environment may be implemented. This may be done to provide a confirmed association between an avatar and a real-world person for purposes of executing a transaction, determining ownership of a product or service in the virtual environment, or enabling an avatar to seek assistance with a virtual product or service, as non-limiting examples. In one embodiment, the disclosed method may include the following verification/authentication steps, stages, functions, processes, or operations:
Determine that a request for verification of the real-world identity of a person corresponding to an avatar has been received from an object or event in a virtual environment;
   In one embodiment, this may be the result of an avatar interacting with an object in the virtual environment, an avatar indicating an interest in purchasing, renting, or using an object in the virtual environment, or an event being generated within the virtual environment;
   In one embodiment, this may be the result of a person in the real-world indicating an interest in purchasing, renting, or using an object in the virtual environment;
In response to the request or event, accessing a blockchain, token, or database containing data comprising:
   Identifiers for a set of avatars in a virtual environment, where each avatar may be associated with a unique name, number, or alphanumeric string, as non-limiting examples;
   For each avatar identifier, an associated set of data or file that may contain one or more of the following, some or all of which may be encrypted:
      A name or unique identifier of a real-world person associated with the avatar identifier;
      Information about the real-world person that may be used as part of an authentication process, such as date of birth, last digits of social security number, mother's maiden name, or favorite color, as non-limiting examples;
      A password or response to a security question;
      A unique identifier associated with an object owned by the avatar/person in the virtual environment or a service the avatar is entitled to receive;
Executing a logical process to determine the real-world person that is associated with the avatar responsible for (directly or indirectly) generating the request for verification, or the avatar associated with a real-world person indicating an interest in purchasing, renting, or using an object in the virtual environment;
   Further, determining if the real-world person associated with an avatar is the person controlling the avatar at that time;
      This may involve a form of authentication such as;
         Sending a message to the real-world person instructing them to control the avatar in a specific way to do something in the virtual environment;
         Requesting that the real-world person or the avatar provide a previously specified and stored password;
         In some embodiments, this might involve a form of two-factor or two-channel authorization that uses both virtual and real-world devices or processes; and
If the real-world person associated with the avatar is determined to be the person controlling the avatar, and if the real-world person (and hence the avatar) is authorized to execute the desired action, then permitting the avatar or real-world person to perform the action or to execute the transaction.

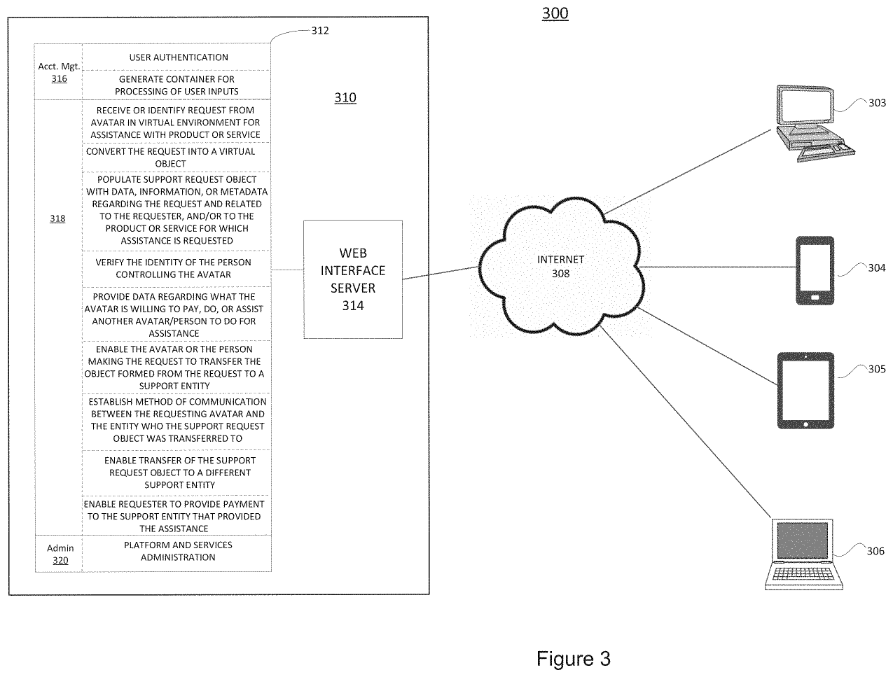

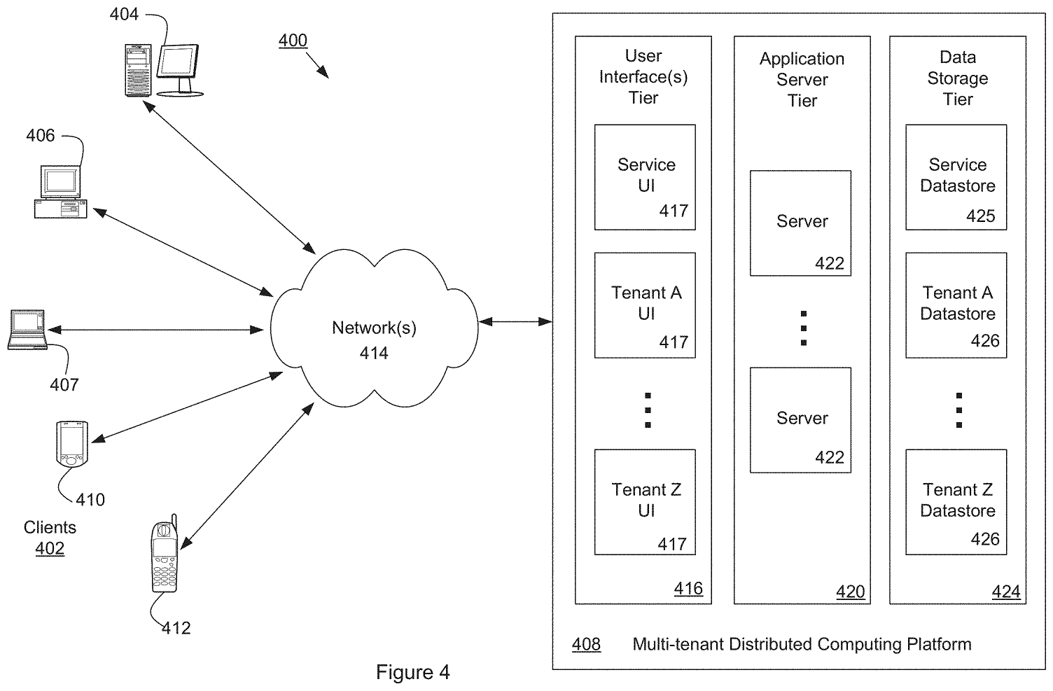

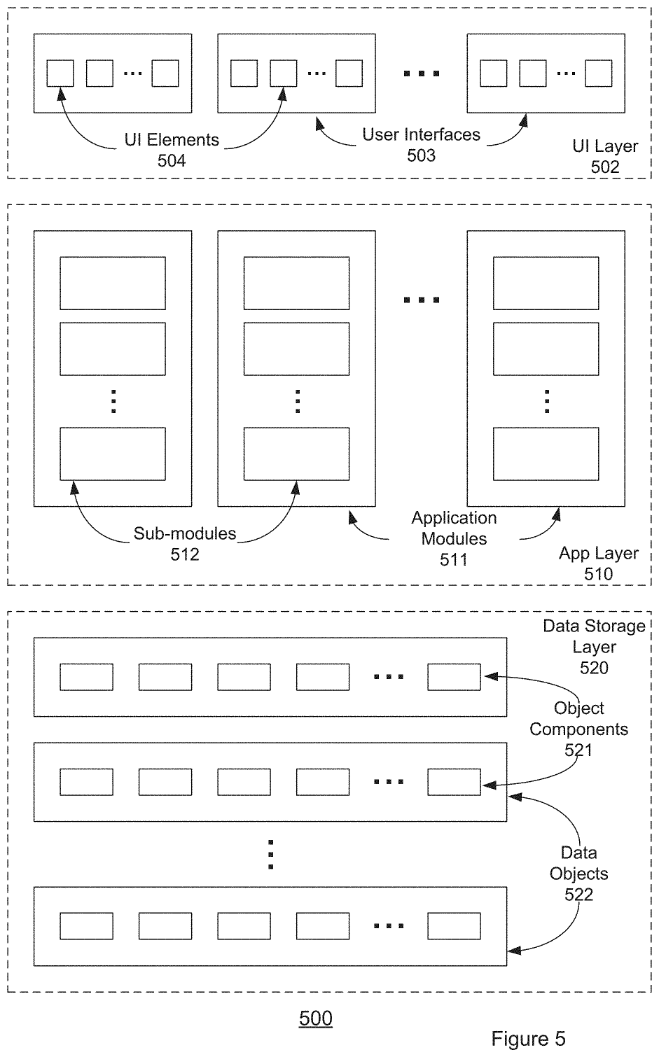

In some embodiments, the functionality and services provided by the system and methods described herein may be made available to multiple users by accessing an account maintained by a server or service platform. Such a server or service platform may be termed a form of Software-as-a-Service (SaaS). FIG. 3 is a diagram illustrating a SaaS system in which an embodiment may be implemented. FIG. 4 is a diagram illustrating elements or components of an example operating environment in which an embodiment may be implemented. FIG. 5 is a diagram illustrating additional details of the elements or components of the multi-tenant distributed computing service platform of FIG. 4, in which an embodiment may be implemented.

In some embodiments, the system or services disclosed herein may be implemented as micro-services, processes, workflows, or functions performed in response to the submission of a service request. The micro-services, processes, workflows, or functions may be performed by a server, data processing element, platform, or system. In some embodiments, the data analysis and other services may be provided by a service platform located “in the cloud”. In such embodiments, the platform may be accessible through APIs and SDKs. The functions, processes and capabilities described herein may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide aspects of the customer assistance and support services in a virtual environment disclosed and/or described herein. Although in some embodiments, a platform or system of the type illustrated in FIGS. 3-5 may be operated by a 3rd party provider to provide a specific set of business-related applications, in other embodiments, the platform may be operated by a provider and a different business may provide the applications or services for users through the platform.

FIG. 3 is a diagram illustrating a system 300 in which an embodiment may be implemented or through which an embodiment of the services disclosed and/or described herein may be accessed. In accordance with the advantages of an application service provider (ASP) hosted business service system (such as a multi-tenant data processing platform), users of the services disclosed and/or described may comprise individuals, businesses, brands, stores, or organizations, as non-limiting examples. A user may access the services using a suitable client, including but not limited to desktop computers, laptop computers, tablet computers, scanners, smartphones, or dedicated VR headsets, for example. In general, a client device having access to the Internet may be used. A user interfaces with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services to assist a user (in the form of their avatar) to obtain customer support within a virtual environment 312, and a web interface server 314, coupled as shown in FIG. 3. It is to be appreciated that either or both the services 312 and the web interface server 314 may be implemented on one or more different hardware systems and components, even though represented as singular units in FIG. 3. Services 312 may include one or more functions or operations for providing support or assistance to a user/avatar in a virtual environment.

As examples, in some embodiments, the set of functions, operations or services made available through the platform or system 310 may include:
Account Management services 316, such as
   a process or service to authenticate a user (in conjunction with submission of a user's credentials using the client device);
   a process or service to generate a container or instantiation of the services or applications that will be made available to the user;
Services 318, such as
   a process or service to receive a request from an avatar in a virtual environment for assistance with a product or service, with the product or service represented as an object in the virtual environment;
   a process or service to convert the request into a virtual object (referred to as a support request object) in the virtual environment (or in some cases, into a real-world service request ticket);
   a process or service to populate or associate the support request object with data and information (such as stored on a blockchain or in the form of an NFT or token), where the data and information may include one or more of data, information, or metadata regarding the request and related to the requester, and/or to the product or service for which assistance is requested:
   a process or service to verify the identity of the person controlling the avatar (if needed);
   a process or service to provide data, information, or metadata regarding what the avatar (and hence the person controlling the avatar) is willing to pay, do, or assist another avatar/person to do in return for assistance in responding to their request;
   a process or service to enable the avatar or the person making the request for support to transfer the object formed from the support request to a support entity, where the support entity may be another avatar, a brand, and may be located in the virtual or real environment (in some embodiments, the avatar or person making the request for support may cause a process to be executed on the support request object so that they can obtain support);
   a process or service to establish a method of communication between the requesting avatar and the entity (e.g., a brand or other avatar) who the support request object was transferred to for resolution so that support can be provided by way of messaging, voice, or video, or through an automated tool (such as a chat bot);
   a process or service to enable the transfer of the support request object to a different support entity if the problem cannot be solved by the entity who first attempted to provide the assistance;
      as described, this may be initiated by either the avatar/person who initially generated the request for support or by a support entity to which the support request object was transferred;
   a process or service to enable the support entity that was able to solve the problem (i.e., to provide the requested assistance) to indicate to the avatar (or person) that generated the request for support that the problem has been solved; and
   a process or service to enable the requester to provide a payment to the support entity (e.g., the avatar or avatars) that provided the assistance;
Administrative services 320, such as
   a processor services to enable the provider of the services and/or the platform to administer and configure the processes and services provided to users, such as by altering a process flow or available options, as non-limiting examples.

The platform or system shown in FIG. 3 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (i.e., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the data analysis and processing described herein) are provided to users, with each business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment may be implemented. The software architecture shown in FIG. 5 represents an example of an architecture which may be used to implement an embodiment of the disclosure. In general, an embodiment of the invention may be implemented using a set of software instructions that are designed to be executed by a suitably programmed processing element (such as a CPU, GPU, microprocessor, processor, controller, state machine, or computing device, as non-limiting examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as a variety of controls, parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user of the platform). Such function, method, process, or operation may include those used to implement one or more aspects of the disclosed system and methods, such as for one or more of the processes or functions disclosed and/or described herein:
Receiving a request from an avatar in a virtual environment for assistance with a product or service, with the product or service represented as an object in the virtual environment;
Converting the request into a virtual object (referred to as a support request object) in the virtual environment (or in some cases, into a real-world service request ticket);
Populating or associating the support request object with data and information (such as stored on a blockchain or in the form of an NFT or token), where the data and information may include one or more of data, information, or metadata regarding the request and related to the requester, and/or to the product or service for which assistance is requested:
Verifying the identity of the person controlling the avatar (if needed);
Providing data, information, or metadata regarding what the avatar (and hence the person controlling the avatar) is willing to pay, do, or assist another avatar/person to do in return for assistance in responding to their request;
Enable the avatar or the person making the request for support to transfer the object formed from the support request to a support entity, where the support entity may be another avatar, a brand, and may be located in the virtual or real environment (in some embodiments, the avatar or person making the request for support may cause a process to be executed on the support request object so that they can obtain support);
Establishing a method of communication between the requesting avatar and the entity (e.g., a brand or other avatar) who the support request object was transferred to for resolution so that support can be provided by way of messaging, voice, or video, or through an automated tool (such as a chat bot);
Enabling the avatar (in one embodiment, based on a recommendation from a support entity) to transfer the support request object to a different support entity if the problem cannot be solved by the entity who first attempted to provide the assistance;
   this may be initiated by either the avatar/person who initially generated the request for support or by a support entity to which the support request object was transferred;
Enabling the support entity that was able to solve the problem (i.e., to provide the requested assistance) to indicate to the avatar (or person) that generated the request for support that the problem has been solved; and
After a response to the request has been received by the requesting avatar, enabling the requester to provide a payment to the support entity (e.g., the avatar or avatars) that provided the assistance.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:

1. A method of providing a service to a user represented by an avatar in a virtual environment, comprising:
receiving a request from an avatar in a virtual environment for assistance with a product or service, with the product or service represented as an object in the virtual environment;
converting the request for assistance into a support request object in the virtual environment;
populating or associating the support request object with data, information, or metadata regarding one or more of the request, the requesting avatar, or the product or service for which assistance is requested;
providing data, information, or metadata regarding what the requesting avatar is willing to pay, do, or assist another avatar to do in return for responding to the request for assistance;
enabling the requesting avatar to transfer the support request object to a support entity;
establishing a method of communication between the requesting avatar and the support entity;
enabling the support entity to indicate to the requesting avatar that the requested assistance has been provided; and
enabling the requesting avatar to provide a payment to the support entity that provided the assistance.

2. The method of clause 1, further comprising verifying the identity of a person controlling the requesting avatar.

3. The method of clause 2, wherein verifying the identity of the person controlling the requesting avatar further comprises:
determining that a request for verification of a real-world identity of a person corresponding to the requesting avatar has been received from an object or event in the virtual environment;
in response to the request, accessing a blockchain, a token, or a database containing data comprising one or more of
   identifiers for a set of avatars in the virtual environment, where each avatar may be associated with a unique name, number, or alphanumeric string;
   a name or unique identifier of a real-world person associated with each avatar identifier;
   information about the real-world person associated with each avatar that may be used as part of an authentication process; and
executing a logical process to verify the identity of the real-world person that is controlling the requesting avatar.

4. The method of clause 1, wherein providing data, information, or metadata regarding what the requesting avatar is willing to pay, do, or assist another avatar to do in return for responding to the request for assistance further comprises enabling the requesting avatar to indicate that the support request object has been placed into a marketplace.

5. The method of clause 3, wherein the blockchain, a token, or a database further comprises a password or response to a security question associated with one or more of the real-world persons, and wherein executing a logical process to verify the identity of the real-world person that is controlling the requesting avatar further comprises:
obtaining an identifier for the requesting avatar;
based on the obtained identifier, determining the name or unique identifier of the real-world person associated with the requesting avatar;
asking the requesting avatar to provide the password or response to a security question associated with the real-world person that is associated with the requesting avatar; and
determining if the password or response to the security question corresponds to the one associated with the real-world person that was accessed from the blockchain, token, or database.

6. The method of clause 1, further comprising enabling the transfer of the support request object to a different support entity if the requested assistance cannot be provided by the support entity who the support request object was transferred to.

7. The method of clause 1, wherein the method of communication between the requesting avatar and the support entity is one or more of a message, a user interface in the virtual environment, a voice communication, a video, or an automated tool.

8. A system, comprising:
one or more electronic processors configured to execute a set of computer-executable instructions; and
one or more non-transitory computer-readable media containing the set of computer-executable instructions, wherein when executed, the instructions cause the one or more electronic processors or a device or apparatus of which they are a part to
   receive a request from an avatar in a virtual environment for assistance with a product or service, with the product or service represented as an object in the virtual environment;
   convert the request for assistance into a support request object in the virtual environment;
   populate or associate the support request object with data, information, or metadata regarding one or more of the request, the requesting avatar, or the product or service for which assistance is requested;
   provide data, information, or metadata regarding what the requesting avatar is willing to pay, do, or assist another avatar to do in return for responding to the request for assistance;
   enable the requesting avatar to transfer the support request object to a support entity;
   establish a method of communication between the requesting avatar and the support entity;
   enable the support entity to indicate to the requesting avatar that the requested assistance has been provided; and
   enable the requesting avatar to provide a payment to the support entity that provided the assistance.

9. The system of clause 8, further comprising instructions that cause the one or more electronic processors or a device or apparatus of which they are a part to verify the identity of a person controlling the requesting avatar.

10. The system of clause 9, wherein verifying the identity of the person controlling the requesting avatar further comprises:
determining that a request for verification of a real-world identity of a person corresponding to the requesting avatar has been received from an object or event in the virtual environment;
in response to the request, accessing a blockchain, a token, or a database containing data comprising one or more of
   identifiers for a set of avatars in the virtual environment, where each avatar may be associated with a unique name, number, or alphanumeric string;
   a name or unique identifier of a real-world person associated with each avatar identifier;
   information about the real-world person associated with each avatar that may be used as part of an authentication process; and
executing a logical process to verify the identity of the real-world person that is controlling the requesting avatar.

11. The system of clause 8, wherein providing data, information, or metadata regarding what the requesting avatar is willing to pay, do, or assist another avatar to do in return for responding to the request for assistance further comprises enabling the requesting avatar to indicate that the support request object has been placed into a marketplace.

12. The system of clause 10, wherein the blockchain, a token, or a database further comprises a password or response to a security question associated with one or more of the real-world persons, and wherein executing a logical process to verify the identity of the real-world person that is controlling the requesting avatar further comprises:
obtaining an identifier for the requesting avatar;
based on the obtained identifier, determining the name or unique identifier of the real-world person associated with the requesting avatar;
asking the requesting avatar to provide the password or response to a security question associated with the real-world person that is associated with the requesting avatar; and
determining if the password or response to the security question corresponds to the one associated with the real-world person that was accessed from the blockchain, token, or database.

13. The system of clause 8, further comprising instructions that cause the one or more electronic processors or a device or apparatus of which they are a part to enable the transfer of the support request object to a different support entity if the requested assistance cannot be provided by the support entity who the support request object was transferred to.

14. The system of clause 8, wherein the method of communication between the requesting avatar and the support entity is one or more of a message, a user interface in the virtual environment, a voice communication, a video, or an automated tool.

15. One or more non-transitory computer-readable media comprising a set of computer-executable instructions that when executed by one or more programmed electronic processors, cause the processors or a device or apparatus of which they are part to
receive a request from an avatar in a virtual environment for assistance with a product or service, with the product or service represented as an object in the virtual environment;
convert the request for assistance into a support request object in the virtual environment;
populate or associate the support request object with data, information, or metadata regarding one or more of the request, the requesting avatar, or the product or service for which assistance is requested;
provide data, information, or metadata regarding what the requesting avatar is willing to pay, do, or assist another avatar to do in return for responding to the request for assistance;
enable the requesting avatar to transfer the support request object to a support entity;
establish a method of communication between the requesting avatar and the support entity;
enable the support entity to indicate to the requesting avatar that the requested assistance has been provided; and
enable the requesting avatar to provide a payment to the support entity that provided the assistance.

16. The non-transitory computer-readable media of clause 15, further comprising instructions that cause the one or more electronic processors or a device or apparatus of which they are a part to verify the identity of a person controlling the requesting avatar.

17. The non-transitory computer-readable media of clause 16, wherein verifying the identity of the person controlling the requesting avatar further comprises:
determining that a request for verification of a real-world identity of a person corresponding to the requesting avatar has been received from an object or event in the virtual environment;
in response to the request, accessing a blockchain, a token, or a database containing data comprising one or more of
   identifiers for a set of avatars in the virtual environment, where each avatar may be associated with a unique name, number, or alphanumeric string;
   a name or unique identifier of a real-world person associated with each avatar identifier;
   information about the real-world person associated with each avatar that may be used as part of an authentication process; and
executing a logical process to verify the identity of the real-world person that is controlling the requesting avatar.

18. The non-transitory computer-readable media of clause 15, wherein providing data, information, or metadata regarding what the requesting avatar is willing to pay, do, or assist another avatar to do in return for responding to the request for assistance further comprises enabling the requesting avatar to indicate that the support request object has been placed into a marketplace.

19. The non-transitory computer-readable media of clause 17, wherein the blockchain, a token, or a database further comprises a password or response to a security question associated with one or more of the real-world persons, and wherein executing a logical process to verify the identity of the real-world person that is controlling the requesting avatar further comprises:
obtaining an identifier for the requesting avatar;
based on the obtained identifier, determining the name or unique identifier of the real-world person associated with the requesting avatar;
asking the requesting avatar to provide the password or response to a security question associated with the real-world person that is associated with the requesting avatar; and
determining if the password or response to the security question corresponds to the one associated with the real-world person that was accessed from the blockchain, token, or database.

20. The non-transitory computer-readable media of clause 15, further comprising instructions that cause the one or more electronic processors or a device or apparatus of which they are a part to enable the transfer of the support request object to a different support entity if the requested assistance cannot be provided by the support entity who the support request object was transferred to.

21. The non-transitory computer-readable media of clause 15, wherein the method of communication between the requesting avatar and the support entity is one or more of a message, a user interface in the virtual environment, a voice communication, a video, or an automated tool.

The disclosed system and methods can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method of providing a service to a user represented by an avatar in a virtual environment, comprising:
receiving a request from an avatar in a virtual environment for assistance with a product or service, with the product or service represented as an object in the virtual environment;
converting the request for assistance into a support request object in the virtual environment;
populating or associating the support request object with data, information, or metadata regarding one or more of the request, the requesting avatar, or the product or service for which assistance is requested;
providing data, information, or metadata regarding what the requesting avatar is willing to pay, do, or assist another avatar to do in return for responding to the request for assistance;
enabling the requesting avatar to transfer the support request object to a support entity;
establishing a method of communication between the requesting avatar and the support entity;
enabling the support entity to indicate to the requesting avatar that the requested assistance has been provided; and
enabling the requesting avatar to provide a payment to the support entity that provided the assistance.

2. The method of clause 1, further comprising verifying the identity of a person controlling the requesting avatar.

3. The method of claim 2, wherein verifying the identity of the person controlling the requesting avatar further comprises:
determining that a request for verification of a real-world identity of a person corresponding to the requesting avatar has been received from an object or event in the virtual environment;
in response to the request, accessing a blockchain, a token, or a database containing data comprising one or more of
identifiers for a set of avatars in the virtual environment, where each avatar may be associated with a unique name, number, or alphanumeric string;
a name or unique identifier of a real-world person associated with each avatar identifier;
information about the real-world person associated with each avatar that may be used as part of an authentication process; and
executing a logical process to verify the identity of the real-world person that is controlling the requesting avatar.

4. The method of claim 1, wherein providing data, information, or metadata regarding what the requesting avatar is willing to pay, do, or assist another avatar to do in return for responding to the request for assistance further comprises enabling the requesting avatar to indicate that the support request object has been placed into a marketplace.

5. The method of claim 3, wherein the blockchain, a token, or a database further comprises a password or response to a security question associated with one or more of the real-world persons, and wherein executing a logical process to verify the identity of the real-world person that is controlling the requesting avatar further comprises:
obtaining an identifier for the requesting avatar;
based on the obtained identifier, determining the name or unique identifier of the real-world person associated with the requesting avatar;
asking the requesting avatar to provide the password or response to a security question associated with the real-world person that is associated with the requesting avatar; and
determining if the password or response to the security question corresponds to the one associated with the real-world person that was accessed from the blockchain, token, or database.

6. The method of claim 1, further comprising enabling the transfer of the support request object to a different support entity if the requested assistance cannot be provided by the support entity who the support request object was transferred to.

7. The method of claim 1, wherein the method of communication between the requesting avatar and the support entity is one or more of a message, a user interface in the virtual environment, a voice communication, a video, or an automated tool.

8. A system, comprising:
one or more electronic processors configured to execute a set of computer-executable instructions; and
one or more non-transitory computer-readable media containing the set of computer-executable instructions, wherein when executed, the instructions cause the one or more electronic processors or a device or apparatus of which they are a part to
receive a request from an avatar in a virtual environment for assistance with a product or service, with the product or service represented as an object in the virtual environment;
convert the request for assistance into a support request object in the virtual environment;
populate or associate the support request object with data, information, or metadata regarding one or more of the request, the requesting avatar, or the product or service for which assistance is requested;
provide data, information, or metadata regarding what the requesting avatar is willing to pay, do, or assist another avatar to do in return for responding to the request for assistance;
enable the requesting avatar to transfer the support request object to a support entity;
establish a method of communication between the requesting avatar and the support entity;
enable the support entity to indicate to the requesting avatar that the requested assistance has been provided; and
enable the requesting avatar to provide a payment to the support entity that provided the assistance.

9. The system of claim 8, further comprising instructions that cause the one or more electronic processors or a device or apparatus of which they are a part to verify the identity of a person controlling the requesting avatar.

10. The system of claim 9, wherein verifying the identity of the person controlling the requesting avatar further comprises:
determining that a request for verification of a real-world identity of a person corresponding to the requesting avatar has been received from an object or event in the virtual environment;
in response to the request, accessing a blockchain, a token, or a database containing data comprising one or more of
identifiers for a set of avatars in the virtual environment, where each avatar may be associated with a unique name, number, or alphanumeric string;
a name or unique identifier of a real-world person associated with each avatar identifier;
information about the real-world person associated with each avatar that may be used as part of an authentication process; and
executing a logical process to verify the identity of the real-world person that is controlling the requesting avatar.

11. The system of claim 8, wherein providing data, information, or metadata regarding what the requesting avatar is willing to pay, do, or assist another avatar to do in return for responding to the request for assistance further comprises enabling the requesting avatar to indicate that the support request object has been placed into a marketplace.

12. The system of claim 10, wherein the blockchain, a token, or a database further comprises a password or response to a security question associated with one or more of the real-world persons, and wherein executing a logical process to verify the identity of the real-world person that is controlling the requesting avatar further comprises:
obtaining an identifier for the requesting avatar;
based on the obtained identifier, determining the name or unique identifier of the real-world person associated with the requesting avatar;
asking the requesting avatar to provide the password or response to a security question associated with the real-world person that is associated with the requesting avatar; and
determining if the password or response to the security question corresponds to the one associated with the real-world person that was accessed from the blockchain, token, or database.

13. The system of claim 8, further comprising instructions that cause the one or more electronic processors or a device or apparatus of which they are a part to enable the transfer of the support request object to a different support entity if the requested assistance cannot be provided by the support entity who the support request object was transferred to.

14. The system of claim 8, wherein the method of communication between the requesting avatar and the support entity is one or more of a message, a user interface in the virtual environment, a voice communication, a video, or an automated tool.

15. One or more non-transitory computer-readable media comprising a set of computer-executable instructions that when executed by one or more programmed electronic processors, cause the processors or a device or apparatus of which they are part to
receive a request from an avatar in a virtual environment for assistance with a product or service, with the product or service represented as an object in the virtual environment;
convert the request for assistance into a support request object in the virtual environment;
populate or associate the support request object with data, information, or metadata regarding one or more of the request, the requesting avatar, or the product or service for which assistance is requested;
provide data, information, or metadata regarding what the requesting avatar is willing to pay, do, or assist another avatar to do in return for responding to the request for assistance;
enable the requesting avatar to transfer the support request object to a support entity;
establish a method of communication between the requesting avatar and the support entity;
enable the support entity to indicate to the requesting avatar that the requested assistance has been provided; and
enable the requesting avatar to provide a payment to the support entity that provided the assistance.

16. The non-transitory computer-readable media of claim 15, further comprising instructions that cause the one or more electronic processors or a device or apparatus of which they are a part to verify the identity of a person controlling the requesting avatar.

17. The non-transitory computer-readable media of claim 16, wherein verifying the identity of the person controlling the requesting avatar further comprises:
determining that a request for verification of a real-world identity of a person corresponding to the requesting avatar has been received from an object or event in the virtual environment;
in response to the request, accessing a blockchain, a token, or a database containing data comprising one or more of
identifiers for a set of avatars in the virtual environment, where each avatar may be associated with a unique name, number, or alphanumeric string;
a name or unique identifier of a real-world person associated with each avatar identifier;
information about the real-world person associated with each avatar that may be used as part of an authentication process; and
executing a logical process to verify the identity of the real-world person that is controlling the requesting avatar.

18. The non-transitory computer-readable media of claim 15, wherein providing data, information, or metadata regarding what the requesting avatar is willing to pay, do, or assist another avatar to do in return for responding to the request for assistance further comprises enabling the requesting avatar to indicate that the support request object has been placed into a marketplace.

19. The non-transitory computer-readable media of claim 17, wherein the blockchain, a token, or a database further comprises a password or response to a security question associated with one or more of the real-world persons, and wherein executing a logical process to verify the identity of the real-world person that is controlling the requesting avatar further comprises:
obtaining an identifier for the requesting avatar;
based on the obtained identifier, determining the name or unique identifier of the real-world person associated with the requesting avatar;
asking the requesting avatar to provide the password or response to a security question associated with the real-world person that is associated with the requesting avatar; and
determining if the password or response to the security question corresponds to the one associated with the real-world person that was accessed from the blockchain, token, or database.

20. The non-transitory computer-readable media of claim 15, further comprising instructions that cause the one or more electronic processors or a device or apparatus of which they are a part to enable the transfer of the support request object to a different support entity if the requested assistance cannot be provided by the support entity who the support request object was transferred to.

21. The non-transitory computer-readable media of claim 15, wherein the method of communication between the requesting avatar and the support entity is one or more of a message, a user interface in the virtual environment, a voice communication, a video, or an automated tool.
